(19) United States
(12) Patent Application Publication
(10) Pub. No.: US 2006/0236950 A1
(43) Pub. Date: Oct. 26, 2006

(54) FISH BARRIER

(76) Inventors: PAUL HENRY PATRICK, TORONTO, ON (CA); OTTO HERRMAN, TORONTO, ON (CA); JOHN STEPHEN GRIFFITHS, TORONTO, ON (CA)

Correspondence Address: LAW OFFICES OF WILLIAM H. HOLT, 12311 HARBOR DRIVE, WOODBRIDGE, VA, 22192, US

(21) Appl. No.: 11/279,587

(22) Filed: Apr. 13, 2006

(30) Foreign Application Priority Data
Apr. 21, 2005 (GB) 0507996.7

(51) Int. Cl. A01K 61/00

(52) U.S. Cl. 119/219

(57) ABSTRACT

A barrier for diverting fish from a water flow channel (42) along which water is to flow, the barrier (45) comprising a generally planar array of fixed upright slats (46) each extending at least the entire depth of the water. The array (45) is set at an angle less than 90° to the initial flow direction, preferably even less than 30°, and each slat is set at an orientation so as to divert water into a direction other than that through the barrier; the spacing between adjacent slats measured along the array is less than 300 mm. For example the flow channel (42) may branch off from a river (40), the barrier (45) being provided at the mouth of the channel (42) so that the barrier is oriented substantially parallel to the flow in the river, and the slats (46) may be at say 60° or 30° to the initial flow direction in the river, so as to divert fish and passively-carried objects along past the barrier and on down the river. (FIG. 3)

This invention relates to a barrier for diverting fish from water intakes for dams, power plants, and other industrial plant that use large quantities of water.

A wide variety of users extract water from bodies of water in the natural environment, such as the sea, lakes, rivers or reservoirs. Water is extracted through water intakes for example for turbines, cooling systems, industrial use, potable water supplies, irrigation canals and desalination plants. In such cases it is usually desirable to prevent or minimise the passage of fish and of debris carried by the water from the body of water into the water intake or outlet, and a variety of different systems for diverting fish and other aquatic life from water intakes have been proposed. For example U.S. Pat. No. 4,169,792 (Dovel) describes a water intake device with a cylindrical rotatable screen which is designed to guide or carry fish and debris away, along with a backwashing device to remove them from the screen. U.S. Pat. No. 1,825,169 (Wyckoff) describes a fish guard for irrigation ditches using a horizontal grate with slats whose orientation can be adjusted but which are directed downstream so that fish are usually swept over the top of the grate, and the slats are adjusted to such a spacing that the spaces are insufficient to accommodate the fish. However, such structures are somewhat complex, having moving parts, and may become blocked with debris or by the growth of algae or shellfish, so that maintenance can be expensive. U.S. Pat. No. 2,826,897 (Vinsonhaler et al) describes a simple fish barrier which uses a louver of fixed vertical slats, angled across a stream of water, each slat being oriented perpendicular to the original flow direction; the slats are typically 50 mm wide and their spacing is preferably between 25 and 75 mm, while the louver is preferably at an angle between 10° and 16° to the original flow direction. It has now been found that such a structure is not optimum for diverting fish, and that it can also cause problems if there is debris carried by the stream.

According to the present invention there is provided a barrier for diverting fish from a water flow channel along which water is to flow, the barrier comprising a generally planar array of fixed upright slats each extending at least the entire depth of the water, the array being set at an angle less than 90° to the initial flow direction, each slat being set at an orientation so as to divert water into a direction other than that through the barrier, and wherein the spacing between adjacent slats measured along the array is less than 300 mm.

The term “initial flow direction” refers to the direction of flow of the water in the place where the barrier is located, in the absence of the barrier. It will be appreciated that the barrier itself affects the water flow, and impedes passage of water through the barrier. The barrier may be installed in a river or channel along which water is already flowing, or may be installed at an outlet from a lake or reservoir, where the water flow occurs because water is extracted. The barrier may be arranged to divert fish and debris into a side channel or bypass channel.

Alternatively the barrier may be installed across the mouth of an offtake channel that branches from a river; in this case, the initial flow direction is that in the river.

In a preferred arrangement each slat is set at an angle no greater than 60° to the initial flow direction but greater than the angle at which the array is set. And preferably the array is set at an angle less than 60° to the initial flow direction.

Preferably the slats are of width between 150 mm and 300 mm. And preferably the spacing between adjacent slats is less than 200 mm, for example 150 mm or 100 mm, but preferably at least 75 mm. The angle of the slat to the initial flow direction is an important parameter, and is preferably less than 50° and more preferably less than 40°, for example 30°. Hence the angle of the array is preferably less than 30°, and more preferably less than 20°, to the initial flow direction. Preferably the angle of the array is between 10° and 20° to the initial flow direction, while the angle of the slats is about 30° to the initial flow direction, and the slats are spaced at a spacing between 80 and 200 mm.

Where biofouling is an issue, the slats may be provided with a coating which suppresses biofouling.

The invention will now be further and more particularly described, by way of example only, with reference to the accompanying drawings in which:

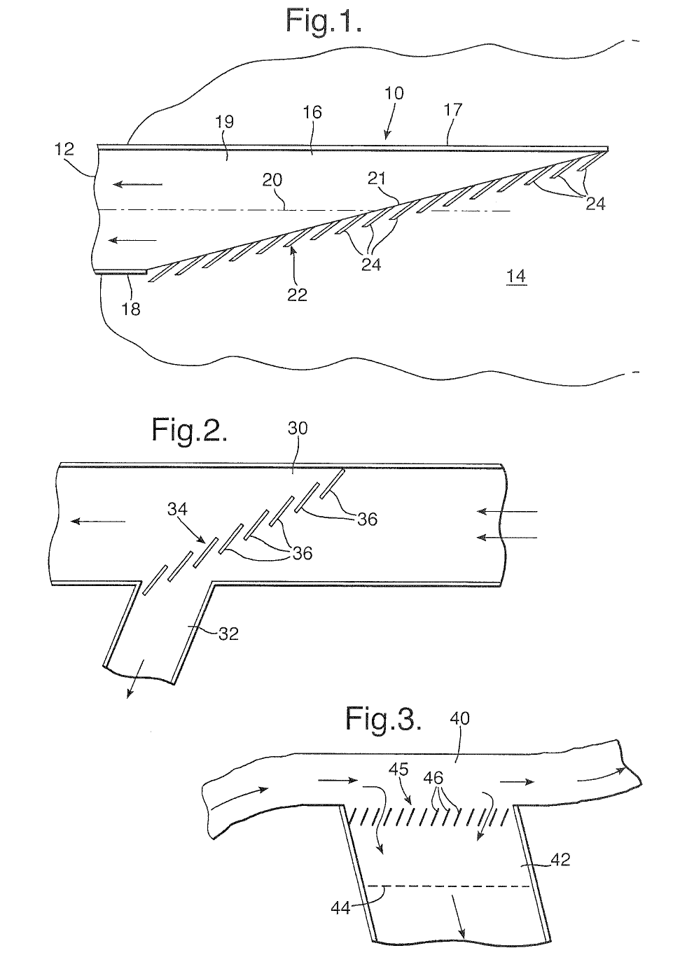

FIG. 1 shows a plan view of a water intake structure incorporating a barrier of the invention;

FIG. 2 shows a plan view of a water intake structure for taking water from a channel, incorporating a barrier of the invention;

FIG. 3 shows a plan view of a water intake structure for taking water from a river, incorporating a barrier of the invention; and

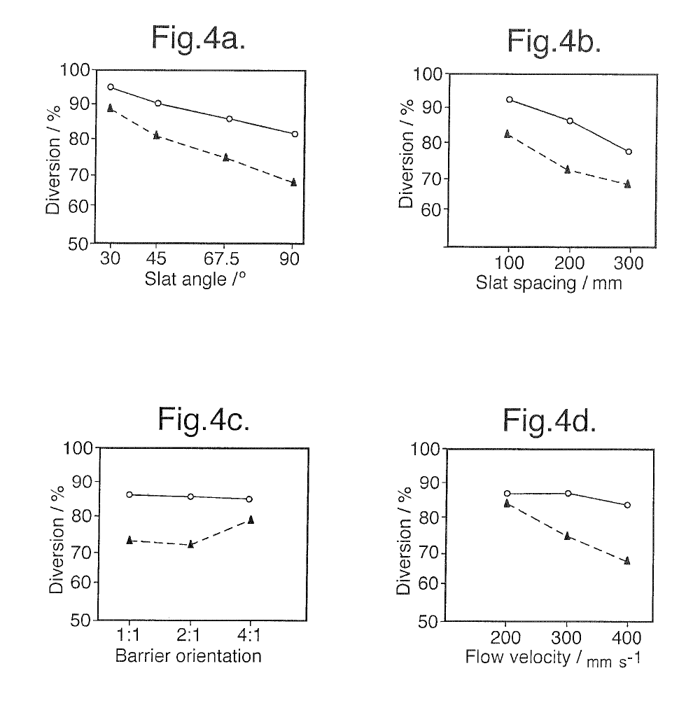

FIGS. 4a-4d show graphically the results of experimental measurements.

Referring now to FIG. 1 there is shown a plan view of an intake structure 10 incorporating a barrier to inhibit fish from reaching a water intake 12 of a power station (not shown). The power station takes coolant water from a lake 14. The intake structure 10 includes an open-ended rectangular channel 16 defined by side walls 17 and 18 and a base 19 which may for example be made of concrete, and which extends out into the lake 14. One side wall 17 extends further into the lake 14 than the other, so that the open end 21 of the channel 16 extends at an angle of about 15° to the longitudinal axis 20 of the channel 16. Across the open end of the channel 16 is a barrier 22 which consists of an array of vertical slats 24 each of width 200 mm, spaced apart at a spacing of 150 mm (measured along the array), each slat 24 being at an orientation of 35° to the longitudinal axis 20. The slats extend the entire depth of the water 24.

In use of the intake structure 10 water is extracted through the intake 12, and there is consequently a flow of water along the channel 16 which would, in the absence of the barrier 22, be approximately in the direction of the longitudinal axis 20. The effect of the slats 24 is to divert some flow away from the channel 16 and back into the lake 14. This has the effect that both fish and any items carried by the current such debris are diverted away from the channel 16 and so do not reach the intake 12. This does not prevent water from flowing into the intake 12, although evidently it imposes a hydraulic constraint on that flow; nevertheless it is very effective at preventing live fish and floating inert objects from reaching the intake 12.

The intake system 10 of FIG. 1 may be modified in various ways, for example two such structures might be arranged side-by-side, sharing a common wall 17, with barriers 22 which are mirror images of each other (so that the overall shape of the two barriers 22 is a V). In a further modification the wall 17 could be omitted.

Referring now to FIG. 2, there is shown an intake which forms part of a flow channel 30 carrying water downhill from a reservoir (not shown) to an irrigation scheme adjacent to a river (not shown), the flow directions being indicated by arrows. In this example a bypass channel 32 branches off from the flow channel 30 to take fish and objects carried by the stream back to the river. A barrier 34 extends diagonally across the flow channel 30 at an angle of 30° to the flow direction along the channel 30, and the barrier 34 consists of an array of vertical slats 36 each of width 250 mm spaced apart at a spacing of 200 mm (measured along the array), each slat 36 being at an orientation of 45° to the initial flow direction along the channel 30. The orientation of the slats 36 is such as to divert water into the bypass channel 32, and their height is at least equal to that of the depth of water.

In operation the effect of the barrier 34 is to divert flow away from the main channel 30 into the bypass channel 32, which has the effect that fish and other objects are diverted out of the main channel 30. Again, this does not prevent water from flowing into the irrigation scheme along the main channel 30, although it imposes a hydraulic constraint on that flow. It will be appreciated that the use to which the water is put, irrigation in this example, does not affect the operation of the barrier, and that such a barrier 34 might be used in other contexts such as the provision of coolant water to a power station. The operation of the barrier 34 could be improved further by using a longer barrier oriented at less than 20° to the flow direction along the channel 30, and decreasing the angle at which the slats 36 are oriented, for example to 30° to the flow direction along the channel 30.

Referring now to FIG. 3, there is shown an intake in which water is extracted from a river 40 to flow along a channel 42 to a power station cooling system (not shown), the channel 42 being provided with travelling screens 44 to remove any objects carried by the flow. The mouth of the channel 42, where it meets the river 40, is provided with a barrier 45 which consists of an array of upright slats 46 each of width 300 mm spaced apart at a spacing of 250 mm (measured along the array), each slat 46 being at an orientation of 70° to the initial flow direction along the river 40, and oriented so as to inhibit flow of water into the channel 42.

In operation, the effect of the barrier 45 is to somewhat inhibit flow of water into the channel 42, and at the same time to ensure that fish and objects carried by the current are swept past the barrier 45 and continue on down the river 40. Consequently there is much less material to be removed by the travelling screens 44. Again, operation of the barrier 45 might be improved by decreasing the angle at which the slats 46 are oriented, for example to 40° or even 30° to the flow direction along the river 40.

In each of these cases the slats 24, 36 or 46 may be made of any suitable strong material, such as wood or concrete, or indeed of a polymeric material, which may be fibre-reinforced. Each slat is preferably coated with a layer of high density polypropylene along its entire length to inhibit biofouling by algae and by shellfish such as mussels (unless the slat itself is made of such material). This may also be augmented by the use of anti-fouling coatings.

The barriers 22, 34 and 45 also minimise problems of biofouling. One potential biofouling problem is that of algal growth. For example in Lake Michigan various filamentous algae grow attached to rocks and other solid surfaces along the shore, the dominant species usually being Ulothrix zonata and Cladophora glomerata. The former usually predominates in the early spring, while the latter becomes predominant in the later spring and summer. Cladophora tends to be the more robust species, and more readily clogs pores and structures. If these algae become detached, for example due to waves, they can form mats near the surface of the water. However, in each case the water flow in the immediate vicinity of the barrier 22, 34 or 45 is such as to tend to cause such floating mats of algae to be carried along the length of the barrier, rather than passing through it. With the barrier 22 of FIG. 1 such floating material is therefore transferred back to the pond 14; with the barrier 34 of FIG. 2 floating material is transferred into the bypass channel 32; while with the barrier 45 of FIG. 3 such floating material is carried on down the river 40.

Experimental measurements have been carried out use a long flow tank along which water was caused to flow continuously, the tank being divided into a main flow path and a parallel bypass towards one end by a wall parallel to the sides of the tank, and provided with a barrier as described above just upstream of the start of this wall, but in which various parameters could be adjusted. In each case observations were made releasing fish well upstream of the barrier, and seeing the percentage that were diverted by the barrier, and the percentage that passed through the barrier. Observations were made while adjusting several different parameters: the angle of the slats to the flow direction along the tank; the angle of the barrier to the flow direction along tank; the spacing of the slats along the barrier; and the flow velocity along the tank. Observations were made with live fish, rainbow trout in particular; and also with passive, anaesthetised, trout to investigate the behaviour of objects that are carried passively by the current.

The angle of the barrier could be 14.1°, 26.6° or 45° (i.e. the ratio of axial distance to transverse distance could be 4, 2, or 1); and the angle of the slats could be 30°, 45°, 67.5° or 90°, although the angle of the slats must be greater than that of the barrier. The slats in each case were 150 mm wide, and the slat spacing could be 100 mm, 200 mm or 300 mm. The flow velocity could be 200, 300 or 400 mm/s. The observations indicated that the slat spacing and the slat angle were the most significant parameters overall.

The best performance was for a slat spacing of 100 mm, and with the barrier at 14.1°, for which over 95% of active rainbow trout were diverted by the barrier for slat angles of 30°, 45°, or 67.5° (for each value of the flow rate). As a general rule the percentage of active trout that were diverted increased as the slat angle decreased, and consequently the best performance was with the barrier at 14.1° (the the smallest slat angles are otherwise not obtainable). With this barrier angle, and with the slats at 30°, the percentage of trout diverted was over 90% with a slat separation of 200 mm (for each value of the flow rate); and even with a slat spacing of 300 mm, over 85% of the trout were diverted.

Referring to FIGS. 4a to 4d, these show graphically the variation of the averaged percentage of fish diverted with each parameter in turn (i.e. averaged for all the values of the other parameters). The observations with active trout are shown with circles linked by a full line, and observations with passive (anaesthetised) trout are shown with triangles linked by a broken line. In every case the barrier is more effective at diverting active fish than passive fish. FIG. 4a shows the variation with slat angle, which in each case increases as the angle becomes smaller, and is best for a slat angle of about 30°. FIG. 4b shows the variation with slat spacing, which in each case shows greater diversion with closer spacing of the slats. FIG. 4c shows the variation with the orientation of the barrier, expressed in terms of the ratio of barrier length (axial distance) to barrier width (transverse distance), using a non-linear scale; for active fish the orientation of the barrier has, on average, little effect, whereas for passive fish the diversion is greatest where the ratio is greatest (corresponding to the smallest angle). FIG. 4d shows the variation with the incident flow velocity, showing that the diversion tends to decrease as the water flows faster, this effect being most marked with passive fish.

We claim:

1. A barrier for diverting fish from a water flow channel along which water is to flow, the barrier comprising a generally planar array of fixed upright slats each extending at least the entire depth of the water, the array being set at an angle less than 90° to the initial flow direction, each slat being set at an orientation so as to divert water into a direction other than that through the barrier, and wherein the spacing between adjacent slats measured along the array is less than 300 mm.

2. A barrier as claimed in claim 1 wherein each slat is set at an angle no greater than 60° to the initial flow direction, but greater than the angle at which the array is set.

3. A barrier as claimed in claim 2 wherein the array is set at an angle less than 60° to the initial flow direction.

4. A barrier as claimed in claim 1 wherein the slats are of width between 150 mm and 300 mm.

5. A barrier as claimed in claim 1 wherein the spacing between adjacent slats is less than 200 mm.

6. A barrier as claimed in claim 5 wherein the spacing between adjacent slats is at least 75 mm.

7. A barrier as claimed in claim 1 wherein the angle of the array is between 10° and 20° to the initial flow direction, while the angle of the slats is about 30° to the initial flow direction, and the slats are spaced at a spacing between 80 and 200 mm.

8. A barrier as claimed in claim 7 wherein the slats are of width between 100 mm and 200 mm.

9. A barrier as claimed in claim 1 wherein the slats are provided with a surface which suppresses biofouling.

10. A barrier as claimed in claim 1 wherein the barrier is installed across the mouth of an offtake channel that branches from a river.
